(19) United States
(12) Patent Application Publication
(10) Pub. No.: US 2025/0376913 A1
(43) Pub. Date: Dec. 11, 2025

(54) APPARATUS AND METHOD FOR STORING CARBON DIOXIDE

(71) Applicant: Noble Drilling A/S, Kgs. Lyngby (DK)

(72) Inventors: Mikkel Søndergaard Pedersen, Thisted (DK); Jan HØFFNER, Jyderup (DK)

(21) Appl. No.: 19/085,795

(22) Filed: Mar. 20, 2025

Related U.S. Application Data
(63) Continuation of application No. PCT/IB2023/058335, filed on Aug. 22, 2023.
(60) Provisional application No. 63/408,539, filed on Sep. 21, 2022.

(51) Int. Cl. E21B 41/00; B01D 53/14

(52) U.S. Cl. CPC E21B 41/0064; B01D 53/1475; B01D 2252/2023; B01D 2252/204; B01D 2257/504; B01D 2258/0283

(57) ABSTRACT

A CO2 capture and storage system has absorbing tower near a source of CO2. The CO2 absorbing tower has a CO2 gas inlet, a gas outlet, an absorbent inlet and an absorbent outlet. A CO2 stripping tower is near a well penetrating a geologic formation. The stripping tower has an absorbent inlet, a gas outlet, an absorbent outlet and a heated fluid inlet. A CO2 condensing unit is disposed proximate the stripping tower and operatively coupled to the gas outlet on the stripping tower. The condensing unit has a compressor and/or a cooler, wherein CO2 gas from condensing unit is converted to liquid. An outlet of the condensing unit is in fluid communication with the well. A pipeline is interposed between the absorbing tower and the stripping tower, wherein the source of CO2 and the well are distal from each other.

Continuation of International Application No. PCT/IB2023/058335 filed on Aug. 22, 2023. Priority is claimed from U.S. Provisional Application No. 63/408,539 filed on Sep. 21, 2022.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

The present disclosure relates to carbon capture and storage (CCS). More particularly, the present disclosure relates to a system wherein carbon dioxide is removed from a flue gas by means of an absorbent, and the carbon dioxide is liquified and deposed into a geologic formation.

In Norway, for examine, the national government provides financial support to the realization of a full-scale CCS project that includes the capture, transport and storage of carbon dioxide (CO2). The project has been named “Langskip”, or “Longship”, and consists of three parts that together constitute the state-funded project Longship.

Once captured, the CO2 is pressurized and stored in a tank as a liquid. The CO2 must be under pressure and in a predefined temperature range to be transportable in the form of a liquid. Then the liquid CO2 is loaded onto a special tank ship, which transports the liquid CO2 to a deposition location. At the deposition location, the CO2 may be pumped into a geologic formation below ground by means of pumping equipment proximate the deposition location.

There is a need for an improved system involving less transfer of liquid CO2 between systems.

### SUMMARY

The present disclosure comprises a CO2 capture and storing apparatus for moving CO2 into a geologic formation, and a method of feeding extracted CO2 into a well. Example embodiments are described in more detail below.

A stripping tower is an integral part of the CO2 storing apparatus according to the present disclosure, and the CO2 is handled in a pipe system with use of separate transportation tanks. Possible advantages of an apparatus and method according to the present disclosure may include one or more of the following. It is easier to handle liquid CO2 in a coherent and closed system compared to transferring liquid CO2 from one system to another by means of tank vessels or tank vehicles. Logistics are more predictable as the handling of liquid CO2 does not depend on local weather conditions. The use of the CO2 storing apparatus becomes more efficient as waiting time for a subsequent CO2 delivery is minimized. The requirement for large temporary storage (buffer) tanks adjacent to the CO2 injection equipment is eliminated.

By operating CO2 injection equipment in an intermittent mode when injecting the CO2 into the geologic formation, the pressure in the geologic formation varies, which may increase the amount of CO2 that can be deposited.

When operating in, for example, a depleted HPHT (high-pressure, high-temperature) well, or another depleted high temperature well, the geologic formation may provide heat energy required by the stripping tower to release the CO2 absorbed by an absorbent. By circulating fluid thus heated in the high temperature well, the heated fluid can pass a heat exchanger heating water passed to a desorber component(s).

A CO2 capture and storage system according to one aspect of the present disclosure has an absorbing tower near a source of CO2. The CO2 absorbing tower has a CO2 gas inlet, a gas outlet, an absorbent inlet and an absorbent outlet. A CO2 stripping tower is near a well penetrating a geologic formation. The stripping tower has an absorbent inlet, a gas outlet, an absorbent outlet and a heated fluid inlet. A CO2 condensing unit is disposed proximate the stripping tower and is operatively coupled to the gas outlet on the striping tower. The condensing unit has a compressor and/or a cooler, wherein CO2 gas from condensing unit is converted to liquid. An outlet of the condensing unit is in fluid communication with the well. The system comprises means for moving the absorbent between the absorbing tower and the stripping tower, wherein the source of CO2 and the well are distal from each other.

Some embodiments further comprise a CO2 storage tank proximate the well and in fluid communication with the outlet of the CO2 condensing unit and the well, wherein CO2 stored in the CO2 storage tank is discharged into the well at selected times.

In some embodiments, the CO2 storage tank comprises a liquid level sensor arranged to measure a level of liquid CO2 in the CO2 storage tank. The system further comprises an injection pump interposed between the CO2 storage tank and the well, wherein the injection pump is actuated to move liquid CO2 to the well from the CO2 storage tank when the liquid level sensor reaches a first predetermined threshold.

In some embodiments, the injection pump is switched off when the level reaches a second predetermined threshold lower than the first predetermined threshold.

Some embodiments further comprise a dehydration tower interposed between the gas outlet of the stripping tower and an inlet to the CO2 condensing unit. The dehydration tower comprises a dehydrating liquid through which CO2 gas and water are passed to extract water from the CO2 gas and water.

In some embodiments, the dehydrating liquid comprises glycol.

In some embodiments, the CO2 absorbing tower comprise liquid absorbent therein, wherein gas entering the CO2 gas inlet bubble upward through the CO2 absorbing tower to extract CO2 from the entering gas.

In some embodiments, the liquid absorbent comprises amine.

In some embodiments, the liquid absorbent comprises carbonic anhydrase.

Some embodiments further comprise a heated fluid pump and a heat exchanger. The heated fluid pump is arranged to circulate fluid through a subsurface well to extract heat therefrom. The heat exchanger is arranged to transfer heat to a fluid entering the heated fluid inlet of the stripping tower, wherein the transferred heat is applied to CO2-laden absorbent moving through the stripping tower to cause release of absorbed CO2.

In some embodiments, the subsurface well is the same well as the well proximate the stripping tower.

Some embodiments further comprise a control unit in signal communication with a liquid level sensor arranged to measure a level of liquid CO2 in the CO2 storage tank. The system further comprises an injection pump interposed between the CO2 storage tank and the well and in control communication with the control unit, wherein the control unit is arranged to operate the injection pump to move liquid CO2 to the well from the CO2 storage tank when the liquid level sensor reaches a first predetermined threshold.

In some embodiments, the control unit is arranged to stop the injection pump when the level reaches a second predetermined threshold lower than the first predetermined threshold.

Some embodiments further comprise an agitator disposed in each of the absorption tower and the stripping tower, each agitator arranged to urge liquid in the respective tower to move downwardly as a result of rotation of each agitator.

In some embodiments, the source of CO2-bearing gas comprises a combustion system, the combustion system discharging CO2-baring flue gas.

In some embodiments, the means for moving comprises a pipeline.

In some embodiments, the means for moving comprises a tank vessel or a tank vehicle.

A method for extracting and storing CO2 from a source of CO2-bearing gas according to another aspect of the present disclosure includes moving the CO2-bearing gas from the source into a CO2-absorbent in a first vessel to generate CO2-rich absorbent, the first vessel disposed proximate the source. The CO2-rich absorbent is moved to a second vessel spaced apart from the first vessel and proximate a subsurface disposal well. The CO2-rich absorbent in the second vessel is heated to release CO2 therefrom. whereupon CO2-depleted absorbent is returned to the first vessel. The released CO2 is condensed into a liquid and is stored until a level of the stored liquid CO2 increases to a first predetermined threshold. The stored CO2 is injected into the disposal well when the level exceeds the first predetermined threshold.

Some embodiments further comprise dehydrating the released CO2 prior to the condensing.

In some embodiments, the dehydrating comprises moving the released CO2 through liquid glycol.

In some embodiments, the absorbent comprises amine.

In some embodiments, the absorbent comprises carbonic anhydrase.

In some embodiments, the heating comprises pumping steam or heated water into the second vessel.

In some embodiments, the heated water or steam is generated by circulating a fluid through a subsurface well and transferring heat from the circulated liquid to a fluid moved into the second vessel.

In some embodiments, the well through which the fluid is circulated is the same well into which the stored CO2 is injected.

In some embodiments, the CO2-bearing as source comprises a combustion plant.

Other aspects and possible advantages of a system and method according to the present disclosure will be apparent from the description and claims that follow.

### BRIEF DESCRIPTION OF THE DRAWINGS

FIG. 1 illustrates schematically a carbon capturing plant according to an embodiment of the invention;

FIG. 2 illustrates schematically one embodiment of a CO2 storing apparatus according to the invention;

FIG. 3 illustrates how the CO2 storing apparatus as illustrated with reference to FIG. 2 is applied for deposing CO2 in a geologic formation via an offshore well;

FIG. 4 illustrates the pipeline shown in cross-section;

FIG. 5 illustrates a CO2 pressure-temperature phase diagram;

FIG. 6 illustrates how the CO2 storing apparatus as illustrated with reference to FIG. 2 is applied for deposing CO2 in a geologic formation via an onshore well; and

FIG. 7 illustrates controlling operating parameters in one embodiment of the CO2 storing apparatus shown in FIG. 2.

FIG. 8 shows an example embodiment wherein transport vehicle(s) may substitute for the pipeline so as to scale the system for small CO2 volume.

### DETAILED DESCRIPTION

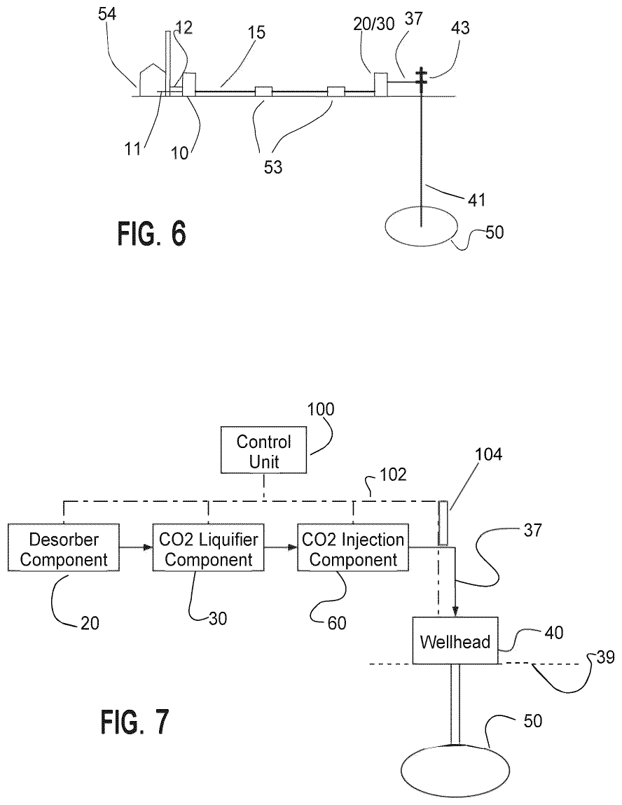

FIG. 1 illustrates schematically an example embodiment of a carbon dioxide (CO2) capturing system 1 according to the present disclosure. The CO2 capturing system 1 comprises an absorbing tower 10 having a flue gas inlet 11 for receiving a CO2 rich flue gas (explained in more detail with reference to FIGS. 5 and 6). The absorbing tower 10 may be a sealed, pressure tight vessel. The absorbing tower 10 contains an absorbent, e.g., a liquid absorbent 10A being able to absorb CO2 from the CO2 rich flue gas when such gas bubbles up from the flue gas inlet 11 through the absorbent 10A. The absorbent 10A is continuously circulated in the carbon capturing system 1 and enters the absorbing tower 10 as CO2-lean absorbent through an absorbent inlet 14 proximate the top of the absorbing tower 10 and passes downwardly through the absorbing tower 10 while absorbing CO2 from the CO2-rich flue gas moving upwardly therethrough to generate CO2-rich absorbent. The CO2-rich absorbent leaves the absorbing tower 10 through an absorbent outlet 13 located proximate the bottom of the absorbing tower 10.

Pumps (not shown in FIG. 1) may be provided in pipes 14A, 13A, respectively, connected to the absorbent inlet 14 and absorbent outlet 13 for ensuring circulation of the absorbent 10A. The CO2-rich flue gas passes through the absorbent 10A from the gas inlet 11 towards a flue gas outlet 12. When bubbling up through the absorbent 10A in the absorbing tower 10, a significant part of the CO2 in the flue gas is absorbed by the absorbent 10A, and the flue gas leaving the absorbing tower 10 through the flue gas outlet 12 will contain a significantly lower concentration of CO2 compared to the CO2-rich flue gas entering the absorbing tower 10.

The CO2 capturing system 1 further comprises a desorber component 20 having a stripping tower 25 in which the CO2-rich absorbent is stripped to remove CO2. The stripping tower 25 may be a sealed, pressure tight vessel. The CO2-rich absorbent enters the stripping tower 25 via an absorbent inlet 21 proximate an upper end of the stripping tower 25 and moves downwardly through the stripping tower 25, then leaves the stripping tower 25 via an absorbent outlet 22 proximate the bottom of the stripping tower 25. Heat energy is applied to the absorbent in the stripping tower 25 to urge the CO2-rich absorbent to release absorbed CO2 before leaving the stripping tower 25. The released CO2 leaves the stripping tower 25 via a CO2 gas outlet 23. The absorbent 10A may be a liquid that is able to absorb CO2 and later release CO2 by supplying energy (e.g., heat) to the CO2-rich absorbent.

In one example embodiment, the heat energy applied to the stripping tower 25 may be provided by steam, fed into the stripping tower 25 through a heated fluid inlet 24, whereupon the steam bubbles up through and heats the absorbent in the stripping tower 25. As will be further explained below, heat energy applied to the stripping tower 25 may be provided by circulating fluid through a subsurface high temperature well.

In some embodiments, agitators 26, 27 may be provided in the absorbing tower 10 as well as in the stripping tower 25, respectively, to assist the downward flow of the absorbent through the respective tower 10, 25. Such agitators 26, 27 may be rotated by a motor such as an electric motor.

In some CO2 capturing systems known prior to the present disclosure, the absorbing tower and the stripping tower are arranged close to each other to minimize the volume of the absorbent required in the CO2 capturing system. According to the present disclosure, the absorbing tower 10 and the stripping tower 25 may be separated from each other (be distal from each other) by a substantial distance and connected via a pipeline 15. The particular distance between the absorbing tower 10 and the desorbing component 20 is not a limitation on the scope of the present disclosure; it is contemplated that the absorbing tower 10 may be disposed proximate a source of CO2-rich flue gas and the desorber component 20 may be disposed proximate one or more subsurface wells through which extracted CO2 are injected into a subsurface geologic formation. The distance between the absorbing tower 10 and the desorbing component 20 according to the present disclosure corresponds to the distance between the source of the CO2-rich gas and a subsurface well into which CO2 is disposed.

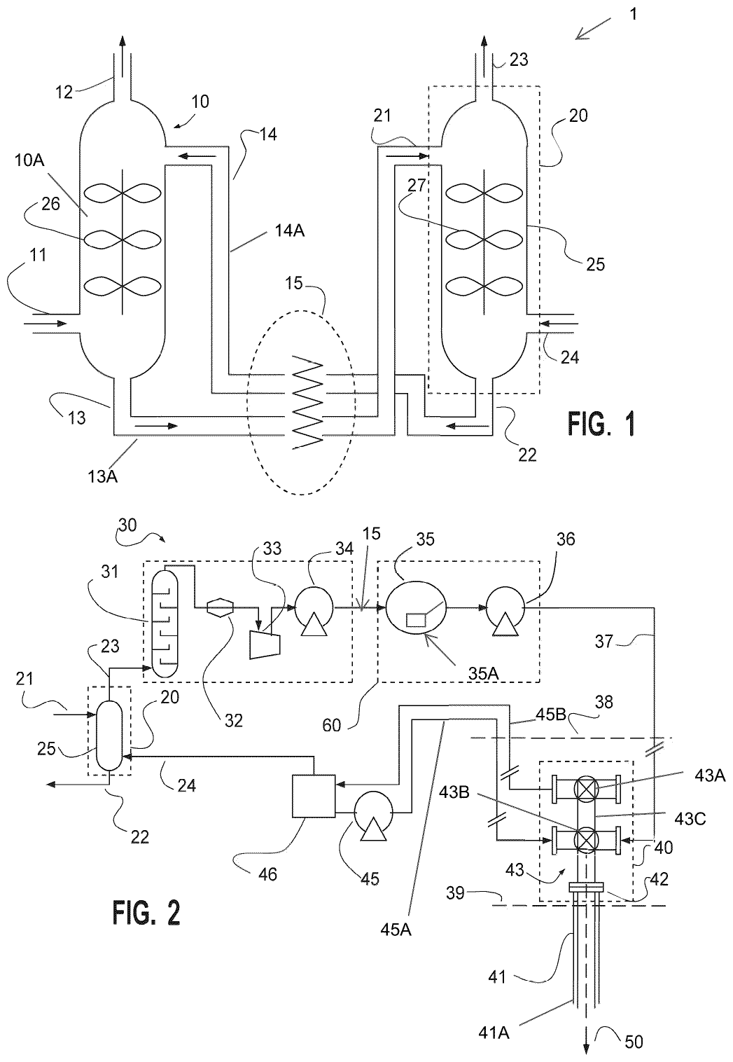

The pipeline 15 may include, as may be observed from a cross-section shown in FIG. 4, a first conduit 16 conducting CO2-rich absorbent from the absorbing tower (10 in FIG. 1) toward the stripping tower (25 in FIG. 1), and a second conduit (17 in FIG. 1) returning CO2-lean absorbent back to the absorbing tower (10 in FIG. 1). The stripping tower (25 in FIG. 1) may thereby be located proximate a well (FIGS. 2, 3, 6) so that large storage tanks (buffer thanks) need not be located proximate the well, and CO2 need not be transported from the capture system (1 in FIG. 1) to the well using tank-bearing transportation vessels. The pipeline 15 may comprise a power cable 18 for powering pumps, heaters, and coolers disposed along the pipeline 15 and provided for conditioning the CO2. The pipeline 15 may include a data cable 19 for monitoring data collected from sensors (not shown) disposed on, in or proximate to the pumps, heaters, and coolers along the pipeline 15, and for forwarding the collected data to a control unit (100 in FIG. 7). The control unit (100 in FIG. 7)) may then operate the pumps, heaters, and coolers (not shown in FIG. 1) along the pipeline 15 according to the data received. The control unit (100 in FIG. 7) ensures that the absorbent maintains rheological properties suitable for circulating between the absorbing tower 10 and the stripping tower 25.

In some embodiments, the power cable 18 may be connected to a switchboard (not shown) adjacent to the stripping tower 25, and the data cable 19 may be connected to the control unit (100 in FIG. 7) as described further below with reference to FIG. 7.

In some embodiments, the absorbent 10A may comprise one or more amines.

Amines are well known for use in gas treating, such as amine scrubbing, gas sweetening and acid gas removal. The absorbing process in some embodiments uses aqueous solutions of various alkylamines (commonly referred to as amines) to remove CO2 from exhaust gases. Many different amines may be used in gas treating, including Diethanolamine (DEA), Monoethanolamine (MEA), Methyldiethanolamine (MDEA), Diisopropanolamine (DIPA), Aminoethoxyethanol, or a combination thereof. In one embodiment, the absorbent is Monoethanolamine (MEA).

In some embodiments, the absorbent 10A may comprise carbonic anhydrase (CA). Carbonic anhydrase is based on zinc-containing metalloenzyme that is widely found in animals, plants, and microorganisms and can catalyze the conversion of CO2 and water into bicarbonate. Carbonic anhydrase is widespread in, e.g., metabolically diverse species of bacteria indicating that such metalloenzyme plays a substantial role in concentrating CO2. The absorbent may be understood as an enzyme solution having carbonic anhydrase activity and catalytic domains, and polynucleotides encoding polypeptides and catalytic domains. Compared to an amine-based absorbent, the enzyme solution having carbonic anhydrase activity requires in general significantly lower amounts of chemicals to be effective for CO2 capturing and a significant lower temperature for releasing the CO2 again.

The difference between carbonic anhydrase systems and amine systems is that the enzymatic solution uses non-toxic and non-corrosive solvents that are effective at lower stripping temperatures than are needed for amine stripping. Lower stripping temperature enables the use of low value heat (e.g., waste heat) and use of hot water instead of steam, which reduces energy costs. An enzymatic solution providing Carbonic anhydrase may be economically beneficial to use in a CO2 capturing system, because, for among other reasons, a particular volume of the enzymatic solution is able to absorb a higher amount of CO2 compared to a similar volume of amine.

FIG. 5 illustrates a CO2 pressure-temperature phase diagram. Th liquid state of CO2 (CO2) cannot exist below atmospheric pressure as may be observed at the Triple Point indicated in FIG. 5. Liquid CO2 can only exist at a pressure above 520 kPa (5.1 atm), at a temperature below 31.1° C. (temperature of the Critical Point in FIG. 5) and above −56.6° C. (the temperature of the Triple Point). Low-temperature CO2 in solid form is known as “dry ice”. Solid CO2 sublimes at 194.65 K (−78.5° C.) at atmospheric pressure, that is, it transitions directly from solid to gas without an intermediate liquid stage.

At the Critical Point (critical state) the boundary between liquid and gas state vanishes. Beyond the Critical Point, CO2 will be a supercritical fluid and there will be no differences in density, surface tension disappears, and the specific latent heat of vaporization is zero. For CO2, the critical point occurs at a pressure of 7.4 MPa and at a temperature of 304.1 K. The density pc of CO2 at the critical point is 469 kg/m³.

According to the present disclosure, CO2 is collected from the desorber component (20 in FIG. 1), is liquified and is temporarily stored in a storage tank (explained below), for finally pumping (injecting) the liquid CO2 into a well drilled through subsurface geological formations for storing in an appropriate geological formation.

FIG. 2 illustrates CO2 storing or sequestration within a geological formation 50 for carbon storage. The geological formation 50 may either or both absorb the injected CO2 or trap the injected CO2. The desorber component 20 has the stripping tower 25 with its absorber inlet 21 for the CO2-rich absorbent and the absorber outlet 22 for the CO2 lean absorbent may be substantially as explained with reference to FIG. 1. The stripping tower 25 discharges CO2 stripped from the absorbent through the CO2 gas outlet 23. The CO2 leaving the desorber component 20 may then be moved to a CO2 condensing component 30.

In some embodiments, the thermal energy (heat) added to the stripping tower 25 for urging the absorbent to release the absorbed CO2 may be added by pumping, for example and without limitation, steam, superheated steam (wherein the steam has been heated above saturation temperature) or hot water. Discharge from the CO2 gas outlet 23 may in such cases include CO2 in combination with water, which under high pressure and at high temperature may constitute a very corrosive mixture. Such mixture may have the capability of corroding even stainless steel tubing and other components downstream in the CO2 capture system. Therefore, the CO2 and water vapor may be moved from the stripping tower 25 to a dehydration tower 31 in the CO2 condensing component 30, where the water-laden CO2 gas is dried, e.g., by contacting dry glycol, wherein the glycol absorbs water from the mixed gas. The CO2 gas leaves the dehydration tower 31 as dry CO2 gas. Dry CO2 gas may be moved through a cooler 32 and a compressor 33, wherein the dry CO2 gas is pressurized and cooled to condense the CO2 into a liquid. A pump 34 may be used for pumping the liquified CO2 into temporary storage, e.g., in a CO2 storage tank 35. The CO2 storage tank 35 may comprise a level sensor 35A arranged to measure liquid level in the CO2 storage tank 35, wherein liquid level measurements may be used as will be explained below with reference to FIG. 7.

A CO2 injection component 60 may be used to move liquid CO2 into a geologic formation 50. The CO2 injection component may comprise the CO2 storage tank 35 and one or more injection pumps 36 for moving the liquified CO2 from the CO2 storage tank 35 toward the geological formation 50. The injection pump 36 may be used for transporting liquified CO2 from the CO2 storage tank 35 through a pipe 37 into a well head 40. The wellhead 40 provides the structural and pressure-containing interface for a well 41 drilled through the geologic formation 50.

The embodiment shown in FIG. 2 may be based on an offshore (marine) well 41 extending below the sea floor 39 toward the geological formation 50. The well 41 may have been drilled by offshore oil drilling equipment of types known in the art, and may be sealed with a steel casing. Just above the sea bed 39, the steel casing has a flange 42 to which a valve assembly (so-called Christmas tree) 43 is mounted. A wellhead 40 may comprise the Christmas tree 43 and may be welded onto the casing. The casing may have been cemented in place during drilling operations, to form an integral structure of the well 41.

When the well 41 has been drilled, it is completed to provide an interface with the geologic formation 50, and a tubular conduit for well fluids. Surface pressure control is provided by the Christmas tree 43, which is installed on top of the flange 42, with isolation valves, e.g., 43A, 43B, and choke equipment (not shown separately) to control the flow of well fluids.

Offshore, when the wellhead 40 is located on a production platform or on a drilling rig above sea level 38, the wellhead 40 is called a surface wellhead, and when the wellhead 40 is located below sea level 38, the wellhead 40 is called a subsea wellhead or mudline wellhead.

The Christmas tree 43 is an assembly of valves, e.g., 43A, 43B, casing spools, and fittings used to regulate the flow through the various pipes in an oil well, gas well, water injection well, water disposal well, gas injection well, condensate well, and other types of well that penetrate certain geologic formations.

During gas or oil production, the primary function of the Christmas tree 43 is to control the flow of oil or gas out of the well 41. However, the Christmas tree 43 may also be used to control the injection of fluids, such as gas or water, into the well 41. Injecting gas, water and/or other fluids into a well are known procedures to enhance production rates of oil from neighboring wells. In the present disclosure, pumping liquid CO2 through the pipe 37, via the Christmas tree 43 of the well head 40, the liquid CO2 enters the well 41 and continues down the well 41 toward the geological formation 50.

In some embodiments, the pipe 37 is a high-pressure CO2 pipeline for transporting CO2 compressed to sufficient pressure to ensure that single-phase flow. The operating pressure may be between 7.4 and 52 MPa or higher. Drilling service companies, among others, can provide pumps such as drilling mud pumps capable of pumping fluid in such pressure range. Above 7.4 MPa, CO2 exists as a single dense phase over a wide range of temperatures, matching the temperature range of the environment, so CO2 may be maintained stable in either liquid phase or as a super critical fluid.

In some embodiments, CO2 is compressed to the desired pressure using a gas compressor or is liquefied at lower pressures by using refrigeration systems and then pumped to the desired pressure. In such embodiments, either the cooler 32 or the compressor 33 may be omitted.

In some embodiments, the CO2 storing apparatus includes a heat transfer fluid pump 45, such as a drilling mud pump, being a reciprocating piston/plunger pump designed to circulate fluid under high pressure in and out of the well 41. When operating, for example, in a depleted HPHT (high-pressure, high-temperature) well, or another depleted high temperature well, the heat transfer pump 45 will circulate fluid heated within the well 41, whereupon the well-heated fluid is passed through a heat exchanger 46 for heating water, steam or another heat transfer fluid passed to the desorber component 20 via the heated fluid inlet 24.

A HPHT well is defined as a well having an undisturbed bottomhole temperature of greater than approximately 150° C. and requiring a pressure control device referred to as a BOP (blowout preventer) with a rating in excess of 10,000 psi (approximately 70 MPa).

In some embodiments, the pump 45 may circulate fluid heated in different well than the well 41 shown in FIG. 2, e.g., an adjacent or neighboring well in order not to mix the circulated fluid and the CO2 to be injection into the geologic formation 50. In some embodiments, the pump 34 fills the CO2 storage tank 35, and when a predetermined tank level has been reached, the injection pump 36 starts to drain the CO2 contained in the CO2 storage tank 35 and move it toward the wellhead 41. The injection pump 36 thereby operates intermittently. In one embodiment, the CO2 is pumped by the injection pump 36 through the pipe 37 as liquid CO2. In some embodiments, carbon sequestration may comprise injecting CO2, as a supercritical fluid into the underground geological formation 50. In some embodiments, the heat transfer fluid may be circulated within the same well as the well used to inject CO2 into the geologic formation; in such embodiments, the heat transfer fluid may be circulated within an annular space between the casing 41A and a nested tube (not shown) inside the casing 41A. Such arrangement will isolate the heat transfer fluid from the CO2 being injected into the well 41. In such embodiments, a heat transfer fluid source conduit 45B and a heat transfer fluid return conduit 45A may be connected to the annular space (not shown).

The example embodiment explained above contemplates using a well otherwise constructed for production of fluid from one or more underground geologic formations, or to inject fluids for purposes of enhanced fluid recovery from an underground formation. The foregoing is not intended to limit the scope of the present disclosure; in some embodiments, one or more wells may be purpose-built for injection of CO2 into the underground geologic formation 50.

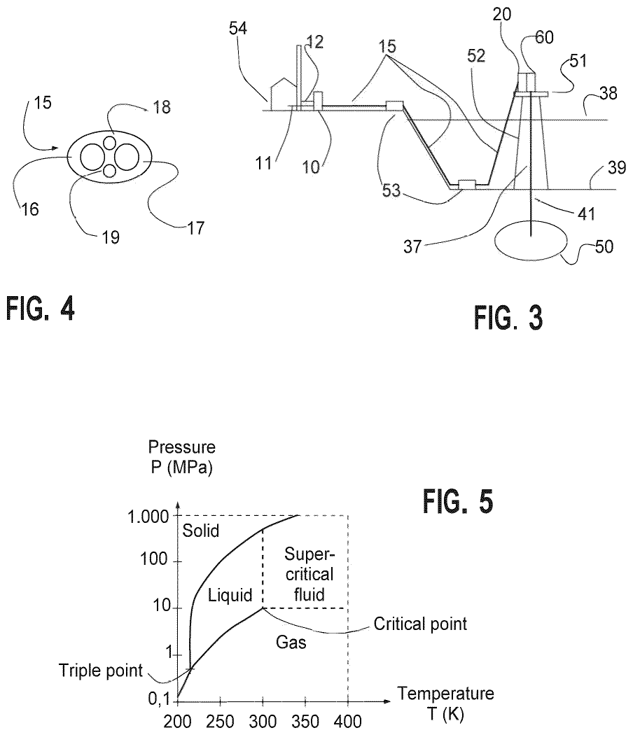

FIG. 3 illustrates how the CO2 storing apparatus as explained with reference to FIG. 2 may be used for injecting CO2 into a geologic formation through a subsurface well 41, such as an offshore well. A combustion system, such as may form part of a power plant or a manufacturing plant 54 producing CO2, delivers CO2-rich flue gas to the absorbing tower 10 through the inlet 11. A significant portion of the CO2 in the flue gas is absorbed by the absorbent in the absorbing tower 10. CO2 leans flue gas leaving the absorbing tower 10 is returned to the plant 54.

The absorbent in the absorbing tower 10 is circulated between the absorbing tower 10 and the stripping tower (25 in FIG. 2) by means of the pipeline 15 and one or more pumps 53 disposed along the pipeline 15, ensuring the absorbent is flowing between the absorbing tower 10 and the stripping tower (25 in FIG. 2). In some embodiments, the absorbing tower 10 may be disposed proximate the plant 54 to minimize the length of conduits (not shown) connecting the flue gas inlet 11 to the plant 54. As shown in FIG. 3, the desorbing component 20 may be disposed proximate the well 41.

In the embodiment shown in FIG. 3, the desorber component 20, the CO2 condenser component (30 in FIG. 2) and an injection component 60 may be placed on an offshore construction comprising a platform 51 resting on a plurality of legs 52. The pipe 37 extends from the CO2 injection component 60 through the platform 51 and the water below and into the well 41. In this way, CO2 may be pumped from the CO2 storage tank (33 in FIG. 2) into the underground geological formation 50.

It is to be clearly understood that while example embodiments disclosed herein are explained with reference to an offshore well, it is within the scope of the present disclosure to store CO2 in underground geologic formations using wells disposed on land rather than below the bottom of a body of water. Such type of well is explained below with reference to FIG. 6.

FIG. 6 illustrates how the CO2 storing apparatus as illustrated with reference to FIG. 2 is applied for deposing CO2 in a geologic formation through an onshore well 41. A combustion system such as may be disposed in a power plant or a manufacturing plant 54 producing CO2 delivers CO2-rich flue gas to the absorbing tower 10 through the inlet 11. A significant portion of the CO2 in the flue gas is absorbed by the absorbent in the absorbing tower 10. CO2-lean flue gas may be returned to the plant 54.

The absorbent in the absorbing tower 25 is circulated between the absorbing tower 10 and the stripping tower 25 by means of the pipeline 15 and one or more pumps 53 ensuring the absorbent is flowing. CO2 is extracted from the absorbent in the stripping tower 25 of the desorber component 20. In the example embodiment shown in FIG. 3, the desorber component 20, the CO2 condenser component 30 and the injection component 60 are placed on or near the ground 55. The pipe 37 extends from the CO2 injection component 60 through a valve assembly (Christmas tree) 43 into the well 41. CO2 may thereby be pumped from the CO2 storage tank (33 in FIG. 2) into the sub-sea geological formation 50.

FIG. 7 illustrates controlling certain operating parameters in one embodiment of the CO2 storing apparatus as shown in FIG. 2. The CO2 storing apparatus in the present example embodiment comprises a control unit 100. The control unit 100 may be, for example and without limitation, a microcomputer, microprocessor, programmable logic controller, field programmable gate array, application specific integrated circuit or any corresponding analog or digital control device. The control unit 100 may be in signal communication with one or more sensors (not shown separately) arranged to monitor parameters in the desorber component 20, such as the absorbent flow rate through the stripping tower (25 in FIG. 2), the CO2 content in the inlet (21 in FIG. 2) and the outlet (22 in FIG. 2), the amount of heat energy applied as water vapor or hot water through the heated fluid inlet (24 in FIG. 2), and the amount of CO2 leaving through the exit (23 in FIG. 2).

The control unit 100 may comprise a data bus 102 for communicating sensor signals from the various elements of the CO2 storing apparatus, including the desorber component 20, the CO2 condenser component 30, the CO2 injection component 60, and the well head 40. Each of the various elements of the CO2 storing apparatus may include a data hub which is a central mediation point for the sensors in this part of the CO2 storing apparatus and the data bus 102. The data hub 104 may comprise data processing facilities for reading sensor data and sending the read sensor data in data packets compliant with the specification of the data bus 102. The data hub 104 may comprise data processing facilities for translating control signals generated the control unit 100 into instructions for controllable elements, e.g., valves, pumps and motors, in the desorber component 20, the CO2 condenser component 30, the CO2 injection component 60, or the well head 40.

In order optimize the CO2 extracting and storage processes, the control unit 100 may, for example, adjust the heat energy applied through the heated fluid inlet (24 in FIG. 2) and the flow through the towers (10 and 25 in FIG. 2) may be controlled by means of the electric agitators (27 in FIG. 2). The control unit 100 monitors various parameters in the CO2 condenser component (30 in FIG. 2), such as the humidity of the water vapor entering and leaving the dehydration tower (31 in FIG. 2) and the temperature and pressure of the gas or liquid flowing toward the CO2 storage tank (33 in FIG. 2). In order to operate within predetermined process parameters, the dehydration tower (31 in FIG. 2), the cooler (32 in FIG. 2), the compressor (32 in FIG. 2), and the pump (34 in FIG. 2) are controlled accordingly.

As long as the stripping tower (25 in FIG. 2) is in operation, the pump (34 in FIG. 2) pumps continuously in order to transfer the liquified CO2 to the CO2 storage tank (35 in FIG. 2). The control unit 100 is configured for monitoring the CO2 injection component 60, including the amount of CO2 present in the CO2 storage tank (35 in FIG. 2), and the pressure and temperature of the CO2. Furthermore, the control unit 100 is configured to the amount of liquid CO2 passing the pump (36 in FIG. 2) and its pressure and temperature.

In some embodiments, the control unit 100 interrogates the liquid level sensor (35A in FIG. 2), wherein when the amount of liquid CO2 in the CO2 storage tank 35 exceeds a first threshold, e.g., 85% full, the control unit 100 starts the injection pump 36. The injection pump (36 in FIG. 2) operates until the control unit 100 detects when the amount of liquid CO2 in the CO2 storage tank (35 in FIG. 2) falls below a second threshold, e.g., 15% full, and then switches off the injection pump (36 in FIG. 2).

The control unit 100 monitors the pressure in the pipe (37 in FIG. 2), in the well (41 in FIG. 2) and in some embodiments, pressure in the well at the interface with the geologic formation (50 in FIG. 2). The control unit 100 may operate the injection pump (36 in FIG. 2) intermittently depending on the amount of liquid CO2 present in the CO2 storage tank (35 in FIG. 2). By operating the injection pump (36 in FIG. 2) intermittently, pressure in the pipe (37 in FIG. 2), the well (41 in FIG. 2) and the geological formation (50 in FIG. 2) fluctuates, which can improve the ability of the geologic formation 50 to absorb CO2.

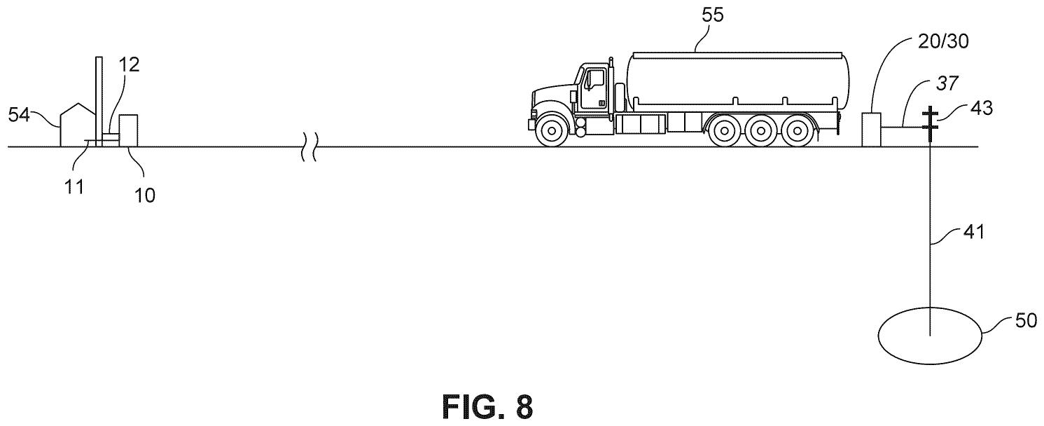

In some circumstances, and referring to FIG. 8, it may be possible to move CO2-laden absorbent from the absorbing tower 10 to the desorbing component 20 using surface transportation vessel or vehicles 55, e.g., one or more tanker trucks moving between the absorbing tower 10 and the desorbing component 20. The embodiment of the system shown in FIG. 8 may include all the components shown in and explained with reference to FIG. 6 other than the pipeline (15 in FIG. 1) and its associated pumps (53 in FIG. 6). Thus, as the absorbing tower 10 discharges CO2-laden absorbent (10A in FIG. 1), the CO2-rich absorbent may be loaded onto the vehicle/vessel 55 and therein transported to the desorbing component 20 for CO2 stripping. CO2-depleted absorbent may be returned to the absorbing tower 10, again using vehicles or vessels. It will be appreciated that while not strictly necessary to operation of the example embodiment shown in FIG. 8, a nominal volume of local buffer storage may be provided. Such storage may be disposed proximate the absorbing tower for the CO2-laden absorbent (10A in FIG. 1) and proximate the desorber component 20 for the CO2-depleted absorbent (10A in FIG. 1). Because the absorbent (10A in FIG. 1) only releases CO2 when heated, transportation of the absorbent between the absorbing tower 10 and the desorbing component 20 may take place in tanks (mounted to a suitable vehicle or vessel) that need not be capable of holding fluid at pressure above atmospheric pressure. Thus, transfer of the absorbent) 10A in FIG. 1) between the respective one of the absorbing tower 10 and the desorbing component 20 on the one hand and the vehicle/vessel 55 on the other does not incur substantial release of CO2 or dangerous gases to the atmosphere. Only suitable safety measures to mitigate liquid spill risk may be needed.

In some embodiments, the example system shown in FIG. 8 may be further modified to include pipes or conduits, and associated pumps, extending between the absorbing unit 10 and remote storage tanks. One such storage tank my hold CO2-laden absorbent for transport by vessel or vehicle to the desorbing component 20; the other tank may receive and store CO2-depleted absorbent for processing in the absorbing tower 10 as explained with reference to FIG. 1. In this way, the absorbing tower 10 may be operated substantially continuously. It will be appreciated that such embodiments may prove particularly useful for instances where the well 41 is located offshore, as explained with reference to FIG. 3, such that absorbent transport may take place using only water-borne vessels (tank ships). Conversely or additionally, some embodiments may comprise pipes or conduits to connect local buffer storage tanks disposed remotely from the desorber component 20, wherein one or more vehicles 55, e.g., tank trucks, move the absorbent between the local buffer storage tanks and the absorbing tower 10. Such embodiments may prove useful in circumstances where water-borne vessels are impractical to use for transporting the absorbent, but use of land vehicles is practical. In such embodiments, the local buffer storage may be located, for example, at a shoreline facility, while the plant 54 may be located inland a substantial distance. Any and all such combinations of pipes and local buffer storage may be used within the scope of the present disclosure in order to provide a practical arrangement of means for moving the absorbent between the absorbing tower 10 and the desorbing component 20

A CO2 capture storage system and method according to the present disclosure may provide one or more possible benefits over CO2 capture and storage known in the art prior to the present disclosure. In some embodiments, a system and method according to the present disclosure may reduce cost and increase safety in some embodiments by eliminating the need to move liquified CO2 over great distances using tank-bearing vessels or vehicles. In some embodiments, cost may be reduced and efficiency may be increased by using heat from one or more subsurface wells to release CO2 from an absorbent rather than by using a separate heat source. CO2 absorbent may be disposed proximate the CO2 gas source while locating CO2 stripping apparatus close to a disposal well, thus eliminating the need for large volume buffer storage near the disposal well. Various embodiments may eliminate the need to transport materials under pressure, thus enabling the use of atmospheric pressure transportation devices. Some embodiments of a system and method according to the present disclosure may be fully closed to atmosphere, thereby eliminating the need for transferring CO2 between tanks, vessels or other system components so as to risk atmospheric exposure when connections between such devices are made and broken. In some embodiments, vehicle or vessel mounted tanks for transporting liquid absorbent need only be made to withstand atmospheric pressure.

In light of the principles and example embodiments described and illustrated herein, it will be recognized that the example embodiments can be modified in arrangement and detail without departing from such principles. The foregoing discussion has focused on specific embodiments, but other configurations are also contemplated. In particular, even though expressions such as in “an embodiment,” or the like are used herein, these phrases are meant to generally reference embodiment possibilities, and are not intended to limit the disclosure to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. A carbon dioxide (CO2) capture and storage system, comprising:
a CO2 absorbing tower disposed proximate a source of CO2-bearing gas from which CO2 is to be removed, the CO2 absorbing tower comprising a CO2 gas inlet, a gas outlet, an absorbent inlet and an absorbent outlet;
a CO2 stripping tower disposed proximate a well penetrating a subsurface geologic formation, the CO2 stripping tower comprising an absorbent inlet, a gas outlet, an absorbent outlet and a heated fluid inlet;
a CO2 condensing unit disposed proximate the stripping tower and operatively coupled to the gas outlet on the striping tower, the CO2 condensing unit comprising at least one of a compressor and a cooler, wherein CO2 gas leaving the CO2 condensing unit is converted to liquid phase, an outlet of the CO2 condensing unit in fluid communication with the well; and
means for moving the absorbent between the CO2 absorbing tower and the CO2 stripping tower, wherein the source of CO2 and the well are distal from each other.

2. The system of claim 1 further comprising a CO2 storage tank proximate the well and in fluid communication with the outlet of the CO2 condensing unit and the well, wherein CO2 stored in the CO2 storage tank is discharged into the well at selected times.

3. The system of claim 2 wherein the CO2 storage tank comprises a liquid level sensor arranged to measure a level of liquid CO2 in the CO2 storage tank, the system further comprising an injection pump interposed between the CO2 storage tank and the well, wherein the injection pump is actuated to move liquid CO2 to the well from the CO2 storage tank when the liquid level sensor reaches a first predetermined threshold.

4. The system of claim 3 wherein the injection pump is switched off when the level reaches a second predetermined threshold lower than the first predetermined threshold.

5. The system of claim 1 further comprising a dehydration tower interposed between the gas outlet of the stripping tower and an inlet to the CO2 condensing unit, the dehydration tower comprising a dehydrating liquid through which CO2 gas and water are passed to extract water from the CO2 gas and water.

6. The system of claim 5 wherein the dehydrating liquid comprises glycol.

7. The system of claim 1 wherein the CO2 absorbing tower comprise liquid absorbent therein, wherein gas entering the CO2 gas inlet bubble upward through the CO2 absorbing tower to extract CO2 from the entering gas.

8. The system of claim 7 wherein the liquid absorbent comprises amine.

9. The system of claim 7 wherein the liquid absorbent comprises carbonic anhydrase.

10. The system of claim 1 further comprising a heated fluid pump and a heat exchanger, the heated fluid pump arranged to circulate fluid through a subsurface well to extract heat therefrom, the heat exchanger arranged to transfer heat to a fluid entering the heated fluid inlet of the stripping tower, wherein the transferred heat is applied to CO2-laden absorbent moving through the stripping tower to cause release of absorbed CO2.

11. The system of claim 10 wherein the subsurface well is the same well as the well proximate the stripping tower.

12. The system of claim 1 further comprising a control unit in signal communication with a liquid level sensor arranged to measure a level of liquid CO2 in the CO2 storage tank, the system further comprising an injection pump interposed between the CO2 storage tank and the well and in control communication with the control unit, wherein the control unit is arranged to operate the injection pump to move liquid CO2 to the well from the CO2 storage tank when the liquid level sensor reaches a first predetermined threshold.

13. The system of claim 12 wherein the control unit is arranged to stop the injection pump when the level reaches a second predetermined threshold lower than the first predetermined threshold.

14. The system of claim 1 further comprising an agitator disposed in each of the absorption tower and the stripping tower, each agitator arranged to urge liquid in the respective tower to move downwardly as a result of rotation of each agitator.

15. The system of claim 1 wherein the source of CO2-bearing gas comprises a combustion system, the combustion system discharging CO2-baring flue gas.

16. The system of claim 1 wherein the means for moving comprises a pipeline.

17. The system of claim 1 wherein the means for moving comprises a tank ship or a tank vehicle.

18. A method for extracting and storing carbon dioxide (CO2) from a source of CO2-bearing gas, the method comprising:
moving the CO2-bearing gas from the source into a CO2-absorbent in a first vessel to generate CO2-rich absorbent, the first vessel disposed proximate the source;
moving the CO2-rich absorbent to a second vessel spaced apart from the first vessel and disposed proximate a subsurface disposal well;
heating the CO2-rich absorbent in the second vessel to release CO2 therefrom and returning CO2-depleted absorbent to the first vessel;
condensing the released CO2 into a liquid and storing the liquid CO2 until a level of the liquid CO2 increases to a first predetermined threshold; and
injecting the stored CO2 into the disposal well when the level exceeds the first predetermined threshold.

19. The method of claim 18 further comprising dehydrating the released CO2 prior to the condensing.

20. The method of claim 18 wherein the dehydrating comprises moving the released CO2 through liquid glycol.

21. The method of claim 18 wherein absorbent comprises amine.

22. The method of claim 18 wherein the absorbent comprises carbonic anhydrase.

23. The method of claim 16 wherein the heating comprises pumping steam or heated water into the second vessel.

24. The method of claim 21 wherein the heated water or steam is generated by circulating a fluid through a subsurface well and transferring heat from the circulated liquid to a fluid moved into the second vessel.

25. The method of claim 22 wherein the well through which the fluid is circulated is the same well into which the stored CO2 is injected.

26. The method of claim 16 wherein the CO2-bearing as source comprises a combustion plant.
